(19) United States
(12) Patent Application Publication
(10) Pub. No.: US 2007/0233794 A1
(43) Pub. Date: Oct. 4, 2007

(54) Email control system utilizing permissions for behavior determination

(76) Inventor: Sundeep Singh, San Antonio, TX (US)

Correspondence Address: WHITE-WELKER & WELKER, LLC, P.O. BOX 199, CLEAR SPRING, MD, 21722-0199, US

(21) Appl. No.: 11/396,861

(22) Filed: Apr. 3, 2006

(51) Int. Cl. G06F 15/16

(52) U.S. Cl. 709/206

(57) ABSTRACT

The present invention is an email control system that utilizes the concepts used in everyday client/server applications where permissions determine the behavior of such systems. Because current permissions strategies are too limiting and archaic in their intelligence and implementation, a new permissions system is to be developed that will use the current client/server applications system as an evolutionary step. The present invention teaches that there are basically three incarnations of the email permissions: Supplied—where specific permissions are supplied and are very precise in what actions are to be taken; Seek—in this case the email has a built in requirement to go out and seek permissions that may be held on a server somewhere and may in the meantime have changed a number of times—very much dependant on the whims of the sender; and Clarify—in this case permissions need clarification according to certain events that may or may not apply and therefore may seek supplied permissions or seek permissions.

### FEDERALLY SPONSORED RESEARCH

Not Applicable

### CROSS REFERENCE TO RELATED APPLICATIONS

Not Applicable

### TECHNICAL FIELD OF THE INVENTION

The present invention relates generally to email control systems. More specifically the present invention relates to an email control system that permissions determine the behavior of the system.

### BACKGROUND OF THE INVENTION

Email evolution has bypassed the control that is inherent and is constantly being developed in other areas of computing. Generally, once email has left the desktop of the sender it is in the Internet ether and dependant on the whims of servers, firewalls and clients. The system of the present invention seeks to counter the conventional developmental wisdom and promote control in the email arena.

Conceptually email systems have lagged behind most other applications since their origin. Email clients and servers, though numerous, have always tended towards re-inventing the wheel resulting in developers constantly duplicating technology and functionality as defined by their predecessors. This developmental approach opens the way for a software engine that transcends current email clients and servers. Therefore it is an objective of the present invention to provide an email engine that not only increases functionality and security, but also, for the first time, offers real email control to the sender.

It is another objective of the present invention to provide an email control system that lends inalienable rights to the sender from the moment the sender clicks on the send button to the point at which the email is deleted by a receiver.

It is another objective of the present invention to provide an email control system that lends control of inclusions or attachments in the email, whatever format they may take, giving the sender control of the viewing, sharing and manipulation of that content.

The email control system of the present invention utilizes concepts used in everyday client/server applications where permissions determine the behavior of software systems. A shortcoming with the current permissions strategies used in everyday client/server applications are too limiting and archaic in their intelligence and implementation. Therefore it is an objective of the present invention to teach a new permissions system that will use current systems as an evolutionary step.

### SUMMARY OF THE INVENTION

The present invention, in its preferred embodiment, consists of an email control system that utilizes the concepts used in everyday client/server applications where permissions determine the behavior of such systems. Because current permissions strategies are too limiting and archaic in their intelligence and implementation, a new permissions system is to be developed that will use the current client/server applications system as an evolutionary step.

The present invention outlines that there are basically three incarnations of the email permissions: Supplied—where specific permissions are supplied and are very precise in what actions are to be taken; Seek—in this case the email has a built in requirement to go out and seek permissions that may be held on a server somewhere and may in the meantime have changed a number of times—very much dependant on the whims of the sender; and Clarify—in this case permissions need clarification according to certain events that may or may not apply and therefore may seek supplied permissions or seek permissions.

The major challenge anticipated in the creation of this system and the effective utilization of this system is the haphazard way in which virus software is utilized and excludes any and all systems that may not conform to it's standardization of the Internet.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates the three incarnations of email permissions;

FIG. 2 defines what email conditions may be set by the present invention;

FIG. 3 illustrates the systems and subsystems necessary to handle email by many forms in the present state of the art;

FIG. 4 is a flow chart illustrating the user process steps;

FIG. 5 illustrates the four areas of activity and the five areas of definition of the system of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

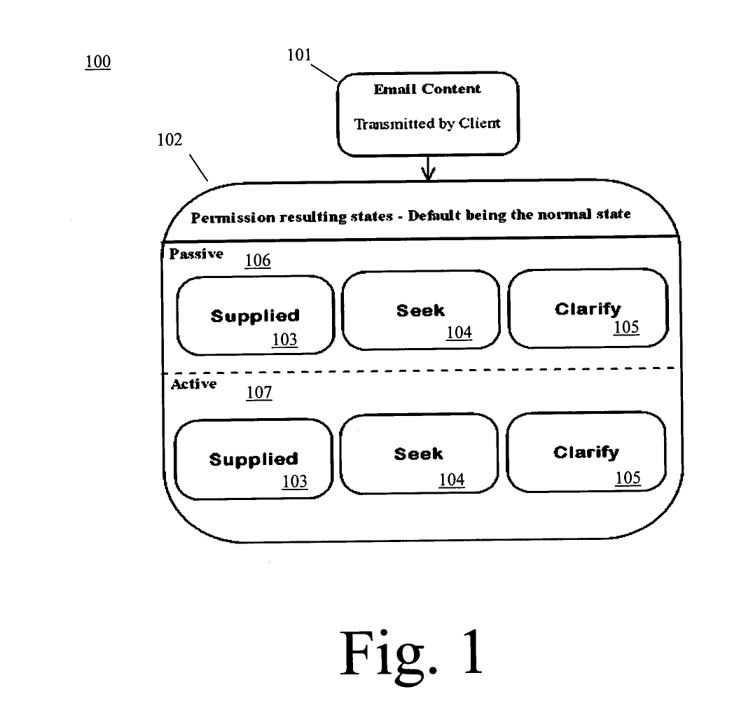

Referring to the figures, it is possible to see the various major elements constituting the present invention. Now referring to FIG. 1, the basic conceptualization of the issue is illustrated. The concept outlines that there are basically three incarnations of the email permissions 102 for controlling email content transmission 101: Supplied 103—where specific permissions are supplied and are very precise in what actions are to be taken; Seek 104—in this case the email has a built in requirement to go out and seek permissions that may be held on a server somewhere and may in the meantime have changed a number of times—very much dependant on the whims of the sender; and Clarify 105—in this case email permissions 102 need clarification according to certain events that may or may not apply and therefore may seek supplied permissions 103 or seek permissions 104.

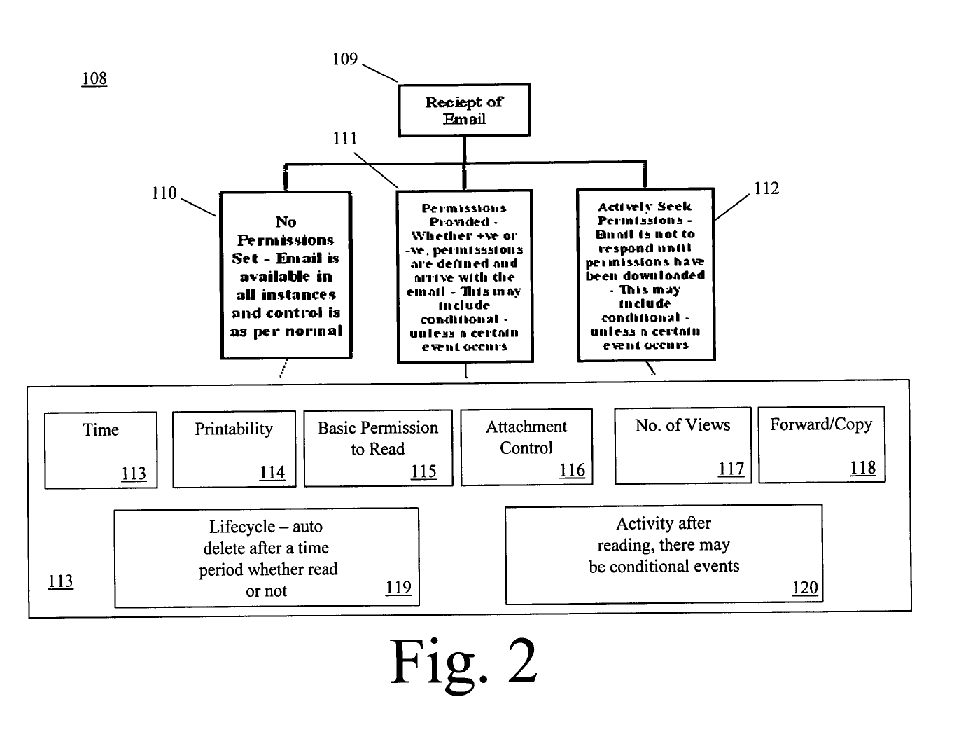

FIG. 2. specifies more clearly what conditions may be set. This, for the purposes of brevity, is a subset of what will be available. Upon the receipt of email 109, either no permissions are set 110, permissions are provided 111, or permissions are actively sought 112. When no permissions are set 110, email is available in all instances an control is as per normal operation known in the prior art. When permissions are provided 111, whether positive or negative permissions are defined and arrive with the email. This may include conditions unless a certain event occurs. Finally, if permissions are actively sought 112, email is not to respond until permissions have been downloaded. This may include conditions unless a certain event occurs as well.

Permissions, limitations, and conditional events include, but are not limited to time 113, printability 114, basic permission to read 115, attachment control 116, number of views 117, and forward/copy functions 118. The permissions, limitations, and conditional events are set to a lifecycle setting 119 that allows auto deletion after a certain time period whether the email has been read or not read. In another embodiment, the permissions, limitations, and conditional events require an activity 120 or other conditional event to occur after the email has been read.

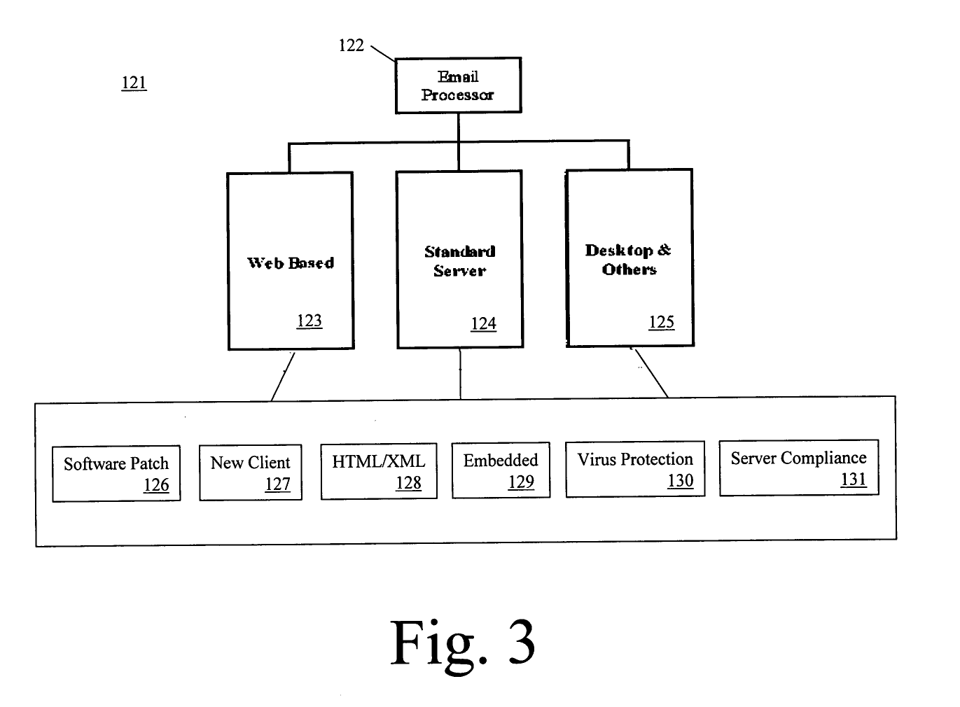

Now referring to FIG. 3. the email processor 122 specifies the acknowledgement that there are a number differing systems and sub systems that are used to handle email. These email handlings systems include web based systems 123, standard servers 124, and desktop systems 125. The system of the present invention will exist and be utilized in many varying forms such as software patches 126, new clients 127, HTML/XML to plug in 128, embedded 129, virus protection 130, and server compliance 131 to actual email clients that may include a subset of the code or may be completely rewritten in order to incorporate these systems.

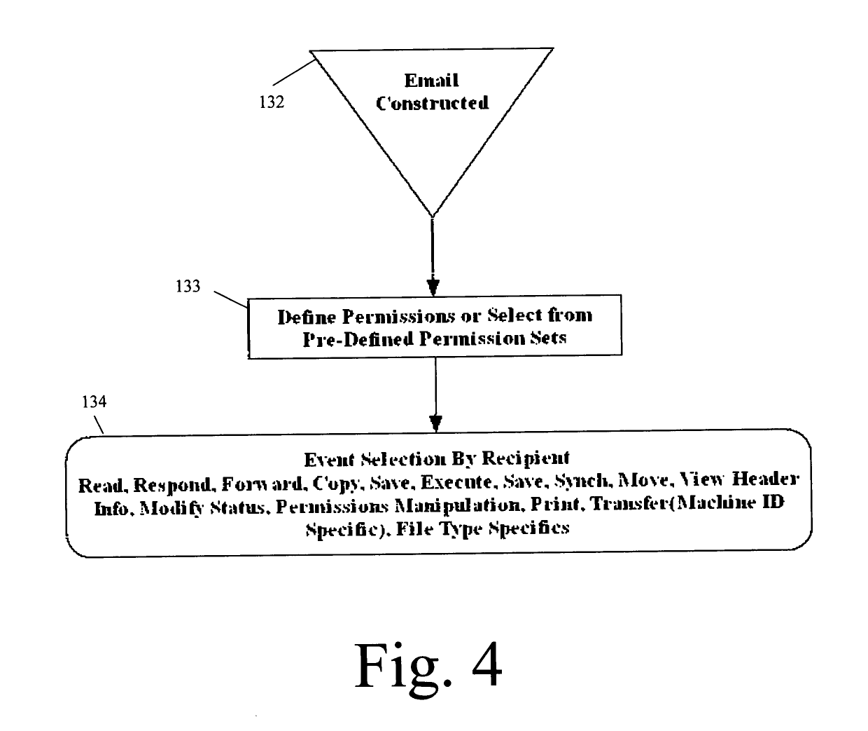

FIG. 4 illustrates the event structure that the sender can define permissions 133 for in the present invention. To alleviate the need for a lengthy process for each email constructed 132, default permission levels will be provided and/or can be defined by the user. Specific high priority permissions can be defined on a per email basis 134. Separate permission sets can be defined for content and for inclusions. Specific event selection by recipients 134 includes the ability to read, respond, forward, copy, save, execute, synch, move, view header information, modify status, permission manipulation, print, transfer, and specify file types.

The single most important of these is the permission sets that define viewing of the email. The importance of this permission definition is that the email must be viewed while online and the permission is an actively sought permission.

An example of this is in the event that an email is sent and then the sender changes his mind and wants to in effect pull the email back from the recipient. This permission set will be polled by the recipient before the email is even displayed in the received emails list. If permission has been retracted then the email will simply not appear so that there is no trace of the email or contents as well as who sent it and when.

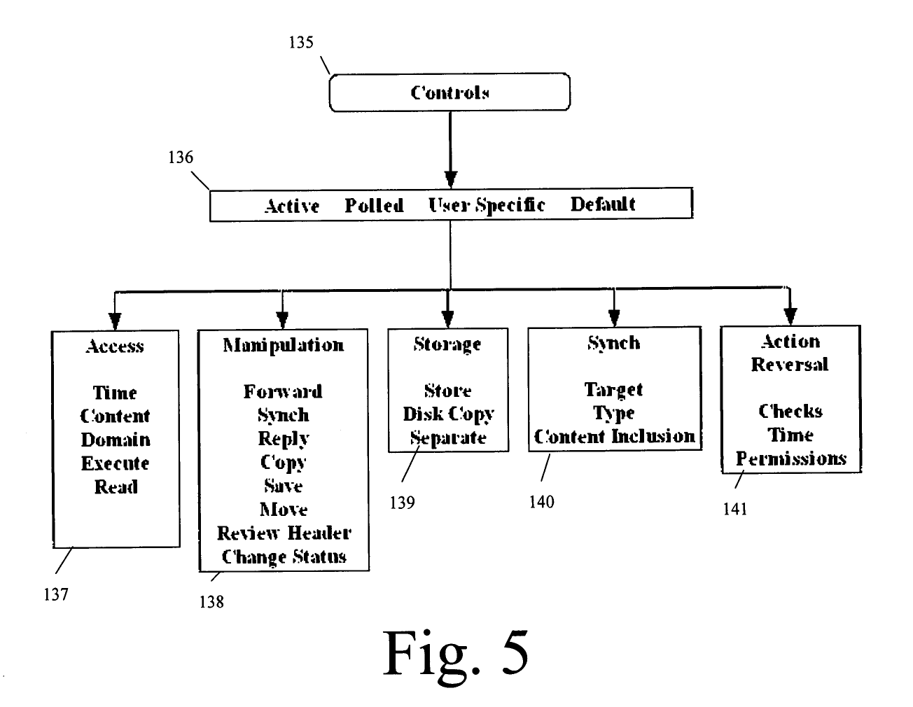

Now referring to FIG. 5 the events and the permission sets that will be available for definition are illustrated. Permissions can be defined in four areas of activity: active, polled, user specific, and default.

Active permissions set by the sender before the email has been sent. These can include permissions that are part of item 3. Permissions in this category are projected along with the email when it is sent.

Polled permissions are permissions that are not included with the email and are stored in a location external to the email, email recipient and email servers. The email polls for these permissions as required. These permissions give the sender the opportunity to modify permissions after sending and up to the point when the email is accessed. This would include when the email is pulled from the email server to an http interface or to a client.

User specific permissions are essential and can partly utilize the built in permissions engines in most of the server and desktop OS applications available today.

Default permissions are set by the sender and do not have to be actively included in each email. These permissions are included automatically unless overridden by any of the other types of activity.

Each of these four areas of activity, active, polled, user specific, and default, can define permissions for five areas of definition, Access, Manipulation, Storage, Synch, and Action Reversal.

Access 137

Time: This is access that is time sensitive. If the email has not been accessed within a certain time then it becomes inaccessible or polls for modification in content and inclusions. This can also include time rendering for content and inclusions in a manner that expires the content even after it has been read but has in stored in any mailbox. Thus you can prevent anyone opening an email after for example 10 days and/or you could say that 24 hours after the email has been read the content and/or the inclusions will no longer be accessible. This has the potential for project info sharing type applications where an update has been sent on a project but every 24 hours it polls for the latest update.

Content: Specific content included in an email whether it is actual content or inclusions can have specific permissions associated with it. Inclusions in an email sent to a number of people that will only be available to some or will only become available if permissions dictate that group approval is required. An example may be accounting information sent to the board and department heads where board review and active approval is required before all departments are able to view the information. This also allows control of access by password protection and access level definition and control.

Domain: Servers often define the domain that users on particular networks and sub networks are a part of. Within and organization a person's system may be part of a workgroup and/or a domain (as defined by the network and differing from our definition of a domain). That restricts the ability of anyone from allowing an email to be accessed outside of tightly defined set of systems within a network and therefore filtering out the content to external systems. Our definition of a domain includes micro domains as defined by a MAC addr (being one machine).

Execute: Execution of certain processes that may be included in an email as executable inclusions can be defined by the permissions allocated to them. Again execution with a domain or by time or even by password protection and other defined and yet undefined security devices, methodologies and systems. Execution of certain inclusions may also be used to pre-empt and even define the access allowed to other recipient and or the recipient who executes the inclusion. This would also interface with the SE polling system to gather information about activity limited to the sent email and it's inclusions.

Read: If a particularly sensitive email is sent with content that would be damaging should it be left displayed on the screen, then this can of course be wrapped in an inclusion with read once and destroy permissions or could be allowed certain read permissions that make the content unavailable even to the display device after a certain length of time or once focus moves from the application or when a confirmation of read has been actively processed by the recipient.

Manipulation

Forward: Permissions control of the ability of the recipient to forward email content and inclusions.

Synch: Synchronization control allowing sender to very closely determine what happens to content and inclusions once viewed by recipient.

Reply: Permissions on replies that will include those below and inclusive of time limitations also.

Copy: When sending replies to emails received with permissions setting the recipient must abide by the rules set out by the sender as to who can be included to receive the reply or who can be included in the forward.

Save: In an effort to control where sensitive information resides controls for saving inclusions and email content can be included in the permissions structure specified.

Remove/Move: Removal or movement of the email content to different folders is also set by permissions.

Review Header: The sender can limit to disallow viewing of header information to protect against information about the senders identity and/or software/hardware being viewed by recipient or others.

Change Status: Changing the status of an email can affect the permissions that have been set by the sender so this will not only be controlled by dependencies but also specifically by the sender.

Storage

Store: Storage of email data whether a copy is left on the server or whether software is used to produce backup copies of emails can be controlled by the sender.

Disk Copy: Permissions allowing or disallowing copy of content or inclusions to disk for storage.

Separate: Permissions determining whether content and inclusions can be separated for storage.

Synch

Target: Synching can be closely permissioned for target vetting.

Type: Determining by permissions the type of synching allowed for the content or inclusions either separately or together.

Content Inclusion: Whether synching is allowed for time sensitive content inclusion i.e. content set to expire in a set amount of time.

Action Reversal

Checks: This exists in the arena of polled permissions. Active polling of the permissions attributed to the content or inclusions can be polled before display or opening to confirm that permissions are still valid.

Time: Time related permissions may change or may be requested for update should time have passed.

Permissions: All permissions can be requested for review by the recipient apart from viewing related permissions that may reverse the send of the email. In those cases the email will not be seen as being present.

In it's simplest forms the SE structure can either approve or disapprove certain email action whereby in it's more complex forms certain macros and a rules based engine is available to “program”. Multiple outboxes will be made available which the user can then define multiple sets of default permissions for. The sender then can select from the outboxes so that the default permissions of that outbox are automatically included.

The recipient of emails will also require certain powers in this scenario. For example if the review of the header information is denied then the situation is ideal for reducing the ability to track the source of emails. The recipient can refuse to accept all emails that have restrictions on header information. In this way spam sources may remove permissions to view header information but recipients who disallow emails with that restriction will refuse that email.

While the invention has been described in terms of several embodiments and illustrative figures, those skilled in the art will recognize that the invention is not limited to the embodiments or figures described. In particular, the invention can be practiced in several alternative embodiments that provides a machine and/or process for generating music, given a set of simple user-specified criteria.

Therefore, it should be understood that the method and apparatus of the invention can be practiced with modification and alteration within the spirit and scope of the appended claims. The description is thus to be regarded as illustrative instead of limiting on the invention.

The embodiments of the invention in which an exclusive property or privilege is claimed are defined as follows:

1. A method of email control utilizing permissions for behavior determination consisting of:
three incarnations of the email permissions 102 for controlling email content transmission;
supplied, wherein specific permissions are supplied and are very precise in what actions are to be taken;
seek, wherein an email has a built in requirement to go out and seek permissions that may be held on a server somewhere and may in the meantime have changed a number of times and is dependant on the sender; and
clarify 105 wherein email permissions need clarification according to certain events that may or may not apply and therefore may seek supplied permissions or seek permissions.

2. The method of email control utilizing permissions for behavior determination of claim 1 wherein upon the receipt of email, either no permissions are set, permissions are provided, or permissions are actively sought.

3. The method of email control utilizing permissions for behavior determination of claim 2 wherein no permissions are set, email is available in all instances an control is as per normal operation known in the prior art.

4. The method of email control utilizing permissions for behavior determination of claim 2 wherein permissions are provided and arrive with the email.

5. The method of email control utilizing permissions for behavior determination of claim 4 wherein positive or negative permissions are defined.

6. The method of email control utilizing permissions for behavior determination of claim 2 wherein if permissions are actively sought, email is not to respond until permissions have been downloaded.

7. The method of email control utilizing permissions for behavior determination of claim 2 wherein permissions include, time, printability, basic permission to read, attachment control, number of views, and forward/copy functions.

8. The method of email control utilizing permissions for behavior determination of claim 2 further comprising a lifecycle setting that allows auto deletion after a certain time period whether the email has been read or not read.

9. The method of email control utilizing permissions for behavior determination of claim 2 wherein the permissions require an activity or other conditional event to occur after the email has been read.

10. The method of email control utilizing permissions for behavior determination of claim 1 which is delivered to a computer system via software patches, new clients, HTML/XML plug in, embedded, virus protection, and server compliance to actual email clients that includes a subset of the code or may be completely rewritten in order to incorporate these systems.

11. The method of email control utilizing permissions for behavior determination of claim 2 wherein to alleviate the need for a lengthy process for each email constructed, default permission levels are provided and can be defined by a user;
specific high priority permissions can be defined on a per email basis; and
separate permission sets can be defined for content and for inclusions.

12. The method of email control utilizing permissions for behavior determination of claim 11 wherein the specific event selection by recipients includes the ability to read, respond, forward, copy, save, execute, synch, move, view header information, modify status, permission manipulation, print, transfer, and specify file types.

13. The method of email control utilizing permissions for behavior determination of claim 11 wherein the single most important of these is the permission sets that define viewing of the email requiring that a email must be viewed while online and the permission is an actively sought permission.

14. The method of email control utilizing permissions for behavior determination of claim 2 wherein permissions can be defined in four areas of activity: active, polled, user specific, and default.

15. The method of email control utilizing permissions for behavior determination of claim 14 wherein active permissions are set by the sender before the email has been sent and are projected along with the email when it is sent.

16. The method of email control utilizing permissions for behavior determination of claim 14 wherein
polled permissions are permissions that are not included with the email and are stored in a location external to the email, email recipient and email server;
said polled permissions give the sender the opportunity to modify permissions after sending and up to the point when the email is accessed. This would include when the email is pulled from the email server to an http interface or to a client.

17. The method of email control utilizing permissions for behavior determination of claim 14 wherein user specific permissions partly utilize the built in permissions engines in a preexisting applications.

18. The method of email control utilizing permissions for behavior determination of claim 14 wherein default permissions are set by the sender and do not have to be actively included in each email and are included automatically unless overridden by any of the other types of activity.

19. The method of email control utilizing permissions for behavior determination of claim 14 wherein each of said four areas of activity, active, polled, user specific, and default, can define permissions for five areas of definition, access, manipulation, storage, synch, and action reversal.

20. The method of email control utilizing permissions for behavior determination of claim 19 wherein
access is further comprised of:
time control requiring that any email not accessed within a certain time becomes inaccessible or polls for modification in content and inclusions;
content control requiring that depending on the content, specific permissions can be associated with the email;
domain control restricting the ability of anyone from allowing an email to be accessed outside of tightly defined set of systems within a network and therefore filtering out the content to external systems;
execute control that provides an email with executable inclusions defined by the permissions;
read control which makes the e-mail's content unavailable even to the display device after a certain length of time or once focus moves from the application or when a confirmation of read has been actively processed by the recipient;
manipulation is further comprised of:
forward permissions that control of the ability of the recipient to forward email content and inclusions;
synchronization control allowing sender to very closely determine what happens to content and inclusions once viewed by recipient;
reply controls the ability of a recipient to reply;
copy control that the recipient must abide by the rules set out by the sender as to who can be included to receive the reply or who can be included in the forward;
save control determines where sensitive information be stored;
removal control restricts movement of the email content to different folders;
review header control enable the sender to limit or disallow viewing of header information; and
change status control locks permissions that have been set by the sender;
storage is further comprised of:
storage control which determines whether a copy of the email is left on the server or whether software is used to produce backup copies of emails can be controlled by the sender;
disk copy control either allows or disallows the coping of content or inclusions to a disk for storage; and
separation control that determines whether content and inclusions can be separated for storage;
synch is further comprised of:
target vetting;
type control for determining, by permissions, the type of synching allowed for the content or inclusions either separately or together; and
content inclusion for determining whether synching is allowed for time sensitive content inclusion i.e. content set to expire in a set amount of time;
action reversal is further comprised of:
check control that requires active polling of the permissions attributed to the content or inclusions that are polled before display or opening to confirm that permissions are still valid;
time related permissions that may change or may be requested for update should time have passed; and
permissions control that provides means for all permissions that can be requested for review by the recipient apart from viewing related permissions that may reverse the send of the email.
